(19) United States
(12) Patent Application Publication
(10) Pub. No.: US 2014/0294216 A1
(43) Pub. Date: Oct. 2, 2014

(54) WATERPROOF SPEAKER USE ON SHIP

(71) Applicant: YI-CHUAN TENG, NEW TAIPEI CITY (TW)

(72) Inventor: YI-CHUAN TENG, NEW TAIPEI CITY (TW)

(21) Appl. No.: 13/851,183

(22) Filed: Mar. 27, 2013

(51) Int. Cl. H04R 1/02

(52) U.S. Cl. CPC H04R 1/02
USPC 381/334

(57) ABSTRACT

The present invention relates to a waterproof speaker use on ship, which also includes a screw and a nut used to combine a vibration board, a first rubber pad, a base seat, a connection board, and a top cover combining with a housing into a unit. The present invention is characterized in that a second rubber pad is provided between the vibration board and the top cover, which can seal the gap between the housing and the top cover that prevents from water leaking into the speaker perfectly.

### FIELD OF THE INVENTION

The present invention is an improvement of U.S. application Ser. No. 09/412,576, now U.S. Pat. No. 6,349,142.

### BACKGROUND OF THE INVENTION

U.S. Pat. No. 6,349,142 relates to a structure of speaker use on ship, which includes a base seat, a vibration board connected to a shaft, and a coil seat connecting a coil. A coil housing enclosing an iron block therein, being made from iron is mounted in between the base seat and the coil seat so as to obtain an effect of magnetism concentration. Furthermore, a pressing machine is used to combine all parts into a unit. A screw and a nut are used to combine the vibration board, a rubber pad, the base seat, a connection board, and a top cover. The rubber pad is used to mount the housing at the connection board. At the bottom of the housing, a mounting rubber ring is provided to allow the passage of power source wires. This patent obtains a certain utility and was allowed. But in use of the speaker, the inventor finds that it can still be improved. Since the speaker is used on a ship, water is easy to spill allover and is possibly leaking into the speaker from the combining gap between the housing and the top cover since both of which are made of metal. This shortage needs to be solved.

### SUMMARY OF THE INVENTION

The present invention is aimed to overcome the drawback of said previous patent of the same inventor. That is, the present invention is to provide a waterproof speaker use on ship, which also includes a screw and a nut are used to combine a vibration board, a first rubber pad, a base seat, a connection board, and a top cover combining with a housing. The first rubber pad is used to mount the housing at the connection board. At the bottom of the housing, a mounting rubber ring is provided to allow the passage of power source wires. The present is characterized in that a second rubber pad is provided between the vibration board and the top cover, which can seal the gap between the housing and the top cover that prevents from water leaking into the speaker. It therefore obtains improvement and utility. Now, accompanying with drawings, the character and structure of the present invention will be disclosed as following.

### BRIEF DESCRIPTION OF THE DRAWINGS

FIG. 1 is a perspective exploded view of a waterproof speaker use on ship according to the present invention.

FIG. 2 is a plan sectional view according to the present invention.

FIG. 3 is a part of an enlarged plan sectional view of FIG. 2.

### DETAILED DESCRIPTION OF THE PREFERRED EMBODIMENT

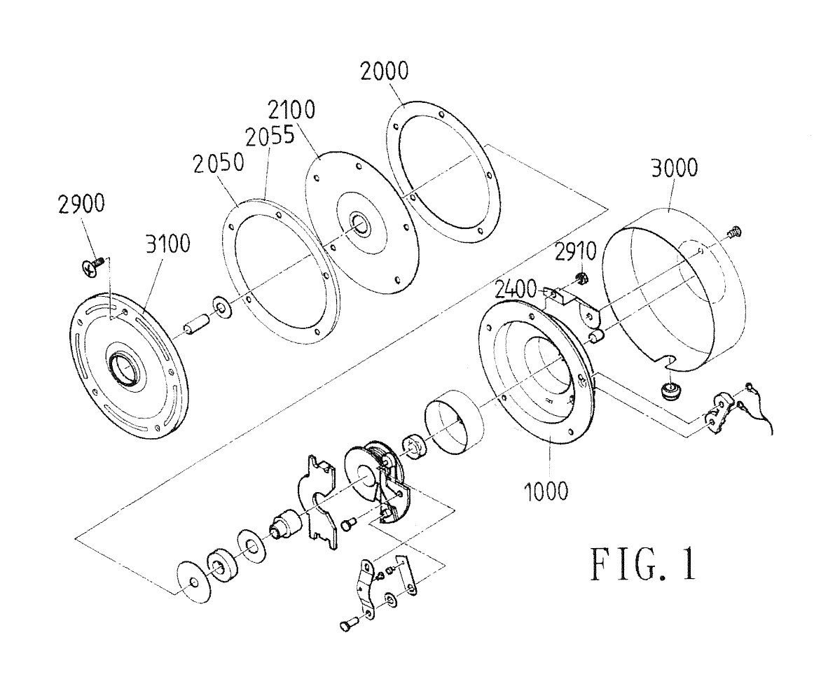

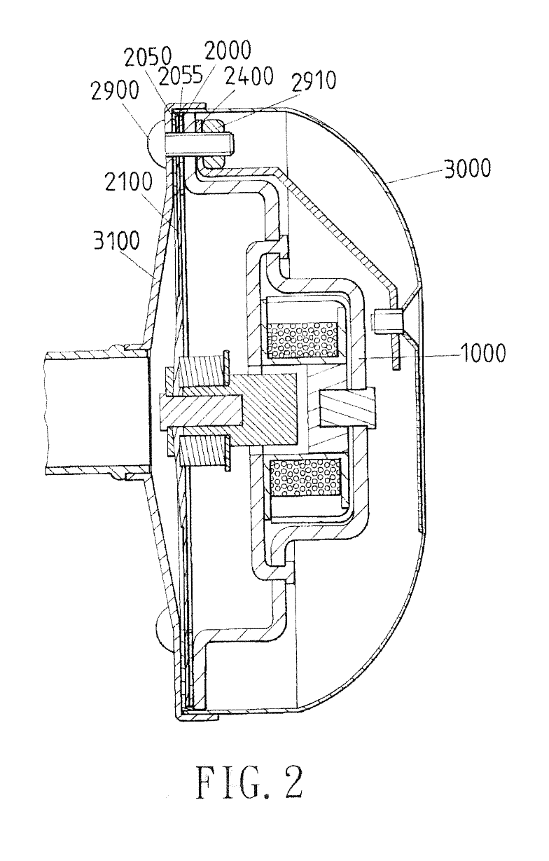

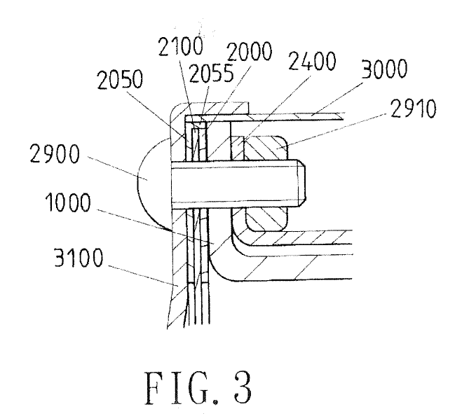

Please refer to FIGS. 1 to 3. The present invention relates to a waterproof speaker use on ship, which includes, as in U.S. Pat. No. 6,349,142, a base seat 1000, a vibration board 2100 connected to a shaft, and a coil seat connecting a coil. A coil housing enclosing an iron block therein, being made from iron is mounted in between the base seat 1000 and the coil seat so as to obtain an effect of magnetism concentration. And, a pressing machine is used to combine all parts into a unit. A screw 2000 and a nut 2910 are used to combine the vibration board 2100, a first rubber pad 2000, the base seat 1000, a connection board 2400, and a top cover 3100. The first rubber pad 2000 is used to mount in a housing 3000 at the connection board 3100. At the bottom of the housing 3000, a mounting rubber ring is provided to allow the passage of power source wires.

A characteristic of the present invention is to provide a second rubber pad 2050 is provided between the vibration board 2100 and the top cover 3100, wherein the second rubber pad 2050 has a convex rim 2055 to engage with the vibration board 2100. After connection, the second rubber pad 2050 will be capable of sealing the gap between the housing 3000 and the top cover 3100 that prevents from water leaking into the speaker. Moreover, the screw 2900 penetrates the second rubber pad 2050 and then connects to the nut 2910 that can thus increase effect of waterproof because of elastic character of the second rubber pad 2050.

Therefore, the present invention obviously obtains improvement and facilitates. And it is to be understood that any modified design according to the merit of the present invention will be still claimed in this application.

I claim

1. A waterproof speaker use on ship including a screw and a nut used to combine a vibration board, a first rubber pad, a base seat, a connection board, and a top cover combining with a housing, in which the first rubber pad being used to mount the housing at the connection board, at the bottom of the housing, a mounting rubber ring being provided to allow the passage of power source wires, and characterized in that a second rubber pad being provide between the vibration board and the top cover.

2. The waterproof speaker use on ship as claimed in claim 1, wherein the second rubber pad having a convex rim to engage with the vibration board.
